(19) United States
(12) Patent Application Publication
(10) Pub. No.: US 2007/0128581 A1
(43) Pub. Date: Jun. 7, 2007

(54) Dental device and method for its use

(76) Inventor: Kevin A. Dustan-Maher, Abu Dhabi (AE)

Correspondence Address: HESLIN ROTHENBERG FARLEY & MESITI PC, 5 COLUMBIA CIRCLE, ALBANY, NY, 12203, US

(21) Appl. No.: 10/580,529

(22) PCT Filed: Nov. 24, 2004
(86) PCT No.: PCT/GB04/04954

§ 371 Date: Feb. 2, 2007

(30) Foreign Application Priority Data
Nov. 24, 2003 (GB) 0327274.7

(51) Int. Cl. A61C 5/00

(52) U.S. Cl. 433/217.1

(57) ABSTRACT

The invention provides a dental device comprising a sheath for fitting over a tooth, the sheath carrying a haemostatic agent in at least one region thereof, wherein the sheath comprises a generally cylindrical body having at least a first end and a second end, at least one of said first and second presenting a circumferential margin carrying at least part of the haemostatic agent, and wherein the at least one end carrying at least part of the haemostatic agent is open to a cavity and the other end is closed. A method of inhibiting or preventing gingival bleeding and a method of retracting gingivae using such a device are also provided.

The present invention relates to a dental device and a method for its use, intended for the inhibition of bleeding and/or retraction of the gingivae during various dental surgery operations.

In the process of constructing a dental crown, bridge or porcelain laminate, the teeth have to be shaped, and impressions taken of the prepared tooth; using a variety of impression materials. It is always essential to control the small amount of bleeding that occurs in the surrounding gingivae, around the periphery of the prepared tooth. It is also essential to retract the gingivae to enable the impression material to take an accurate impression of the margins of the preparation.

The usual method of controlling bleeding and retracting tissue is by the use of retraction cords. These are fine cords impregnated with epinephrine, racemic adrenalin hydrochloride and noradrenaline (synthetic adrenalin) or astringents such as ferric or aluminium chloride.

The cords must be laboriously packed around the gingival margin of each prepared tooth and gently compressed into the sulcus with a special gingival retraction cord packer. The procedure is often difficult and time consuming, but is essential for successful impression taking.

Therefore, there is a need to provide a means for applying a haemostatic agent quickly and accurately into the gingival sulcus to control bleeding and to retract tissue. The present invention achieves this by means of a sheath which carries a haemostatic agent and is adapted to fit over the tooth.

A known dental product comprises compressible cotton wool caps but these are not functional to reduce or prevent bleeding by application of a haemostatic agent. Specifically, such pressure caps have a shape which is even and constant whilst that of the sulcus is not. Moreover, since these caps compress during use, the edge of the cap cannot be forced into the gingivae. Consequently, such caps must generally be used in conjunction with a gingival retraction cord and since use of the caps alone does not ensure accurate or sufficient retraction of the gingivae. Such pressure caps do not contain any haemostatic agents. Thus, any haemostasis achieved by the use of such caps is the result of pressure applied to the general area of treatment by the presence of such caps. Examples of such pressure caps are sold under the trade name “Comprecap” and are manufactured by Roeko GmbH & Co. KG, Germany.

WO 02/102269 discloses a device for retracting gingival tissue away from a tooth comprising a preformed integral closed loop of material sized and dimensioned to be packed into a sulcus associated with the tooth, the closed loop having an inner surface suitable for placement against the at least one tooth and an outer surface suitable for placement against gingival tissue. The loop is preferably deformably rigid, extensive and non-elastic. The material is preferably compressible and absorbent and may be soaked or otherwise impregnated with an astringent or haemostyptic. The device may also comprise several such loops linked together at their periphery to form a chain-like unitary structure. However, such a device is effectively a more sophisticated form of retraction cord. Thus, it must generally still be manually packed into the sulcus by a dental practitioner using appropriate tools.

U.S. Pat. No. 3,238,620 discloses a device for retracting gingival tissue from a tooth and controlling bleeding which is in the form of a circular ring of absorbent, resilient material of uniform cross sectional shape. The ring may be treated with a haemostatic or vaso-constrictive solution before or during use to control bleeding. However, once again, this device must be manually packed into the sulcus by a dental practitioner using appropriate tools, which can be both time-consuming and traumatic for the patient.

A first aspect of the present invention provides a dental device comprising a sheath for fitting over a tooth, the sheath carrying a haemostatic agent in at least one region thereof, wherein the sheath comprises a generally cylindrical body having at least a first end and a second end, at least one of said first and second ends presenting a circumferential margin carrying at least part of the haemostatic agent, and wherein the at least one end carrying at least part of the haemostatic agent is open to a cavity and the other end is closed.

A second aspect of the present invention provides a method of inhibiting or preventing gingival bleeding, the method comprising placing over a tooth, a device according to the first aspect of the present invention and, optionally, applying pressure to the device.

A third aspect of the present invention provides a method of retracting gingivae, the method comprising placing over a tooth a device according to the first aspect of the present invention and, optionally, applying pressure to the device.

The present invention permits drying and isolation of the preparation from contaminating saliva and thus creates an environment for a more accurate impression, around the preparation margins.

The present invention can also be used following the removal of temporary crowns prior to cementing the permanent crowns, where its action will be similar i.e. controlling any bleeding, drying and isolating the tooth from the contaminating saliva, reducing the need for painful air-drying of the prepared tooth.

A dental device according to the first aspect of the present invention comprises a sheath for fitting over a tooth. This can be placed over a tooth prior to preparation or after preparation. This sheath comprises a generally cylindrical body having a first end and a second end, at least one of the first and second ends presenting a circumferential margin carrying at least part of the haemostatic agent.

The term “generally cylindrical” is not confined to generally cylindrical shapes having an axis of symmetry or indeed, to a perfect cylinder having a circular cross-section. The cross-section or shape may be regular or irregular. Possible regular shapes include oval or elliptical or square or rectangular shapes in cross-section, or indeed any polygonal shape, especially a generally polygonal profile having rounded corners. The shape could also be adapted to correspond to that of a given kind of tooth.

As used herein, the term “haemostatic agent” covers any substance or combination of substances which slow or prevent the flow of blood by any mechanism, be it clotting, vasoconstriction or any other mode of action. Suitable haemostatic agents include epinephrine and salts thereof, and astringents such as ferric chloride or, ferric sulphates, aluminium chloride, aluminium sulphate and any mixtures of the foregoing. If the haemostatic agent can exist in different isomeric or enantiomeric forms, mixtures of isomers (including racemic mixtures) or individual isomers or enantiomers may be used. A particularly preferred haemostatic agent is racemic epinephrine hydrochloride.

The haemostatic agent is carried in at least one region of the sheath. In this context, “carrying” can refer to impregnation or coating of the relevant region or regions, or both. The haemostatic agent may be applied to the relevant region by any suitable means, such as dissolved in a suitable solvent, followed by drying or applied as a comminuted solid, e.g. by means of an orally compatible adhesive substance.

In the device according to the present invention, the at least one end carrying at least part of the haemostatic agent is open to a cavity and the other end of the device is closed. Preferably, such a cavity progressively narrows from the open end towards the closed end. For instance, the cavity may be conical or, more preferably, terminate in a dome-shape at its closed end. It is also preferred for the closed end to be constructed so as to yield upon application of pressure, for example by virtue of the body of the device comprising or being plugged with cotton wool or any other resilient substance and/or being provided with slots or other means to allow the closed end to splay upon application of pressure. However, in an alternative preferred embodiment, the closed end may be constructed so that it maintains its original shape and/or integrity upon application of pressure.

Preferably also, the walls of the sheath are stiffened, but most preferably still retain some flexibility. This may be achieved by a construction utilising cellulose or other polymeric material or sheathing with paper or other non woven web. Alternatively, the body of the device may be treated with a suitable non-toxic material, such as, gelatin, shellac, cellulose, starch, polysaccharide or other polymeric materials. In this respect, gelatin is especially preferred. In general, the body of the device may be made of one or more suitable substances such as cotton wool, wool, fleece, wool felt, a cellulose, thin blotting paper, any suitable plastics material, including polythene (low density, medium density or high density), Visqueen™, synthetic or natural rubbers, including silicone rubbers, other silicones, papers, cardboards, fibreboards, metals such as soft aluminium or soft copper and wood as well as any laminate or composite or other combination of any two or more of the foregoing. A particularly preferred material is fleece or sheep's wool which has been processed into high density felt. Preferably, the wool felt should have a density of 35-100 kg/m³, more preferably 60-80 kg/m³, and especially about 65 kg/m³. Ideally, the device should have sufficient integrity that it is able to transmit load under compression but also be sufficiently flexible so that it can conform to the shape of the tooth or stump over which it is to be applied. The stiffening should not be too rigid, otherwise the occlusal pressure on the upper end could damage the delicate peripheral gingivae around the tooth.

A preferred class of embodiments comprises a resilient body such as of cotton wool, preferably with a cavity such as described above and a wall surrounding the body, e.g. of a stiffening material such as mentioned above.

An alternative preferred class of embodiments comprises a resilient body of wool felt with a cavity as described above which has been stiffened by application of a suitable non-toxic material, preferably gelatin.

For effective operation, it is important that the shape of the cavity in the device of the invention is closely aligned to the shape of the tooth or stump over which it is to be applied. It is therefore convenient to provide a set of devices according to the present invention, at least two of the devices in the set being of different sizes relative to each other, adapted for fitting over different sizes of teeth, e.g. large molars, small molars, pre-molars and incisors/laterals. Suitable devices range from about 10 to 18 mm, preferably 12 to 15 mm, in height and have a diameter or width of from about 5 to 15 mm, preferably 7 to 12 mm. The diameter or width of the cavity may be from 4 to 14 mm, preferably 6 to 11 mm. Thus, the thickness of the wall of the device at its open end is ideally from 0.5 to 1.0 mm, preferably 0.5 to 0.75 mm, thereby facilitating entry of the wall into the sulcus. It is also convenient for each such different size to be colour-coded for ease of recognition. Colour coding may, for instance, be achieved by dyeing the raw material used to form the device prior to manufacture, applying a coloured coating or stripe to the outside of the device, or utilising coloured packaging.

Devices according to the present invention can be manufactured in a variety of ways. For instance, the material from which the devices are to be manufactured, e.g. wool felt, can be extruded into a rod and the rod can then be cut into appropriate lengths to form blank plugs. Alternatively, suitably shaped billets can be punched out from a sheet of the material. A tapered router of suitable profile is then used to hollow out a suitably shaped cavity in each plug or billet. Preferably, a suitable stiffening material, e.g. gelatin, is then applied to the device. Ideally, this is applied as a coating. The stiffening material may be applied to the entire external surface of the device or just to the closed end and the part of the external walls adjacent the closed end. Alternatively, the entire device or part thereof may be impregnated with stiffening material. A haemostatic agent is then applied to the end of the device which is open to the cavity. Colour coding may be effected at this stage by coating the external surface of the device or part thereof, e.g. a stripe, with a suitable dye or other coloured material. Alternatively, the material from which the devices are to be manufactured can be dyed prior to use.

In use, a device according to the present invention may be placed over the prepared tooth or stump and the patient may then be instructed to bite his teeth together onto the device. This will have the effect of forcing the wall of the device at its open end into the sulcus thereby retracting the gingivae. Since the wall at the open end, which defines the cavity, is treated with a haemostatic agent, this action will also control any bleeding. Moreover, the absorbent nature of the device allows drying and isolation of the prepared tooth or stump from saliva. This method is particularly suitable for teeth in the part of the mouth where upper and lower teeth are aligned and the upper surfaces of these teeth therefore impact upon each other when biting, e.g. pre-molars and molars. However, for teeth which are not aligned in this way, e.g. incisors and canines, it may be more convenient for the dental practitioner to apply the device of the invention using manual pressure.

Devices according to the present invention may be used in any one of a variety of dental surgery operations, such as crowns or bridge work, implants, laminates and even routine conservative procedures where bleeding control and/or retraction of the gingivae is required.

The present invention will now be explained in more detail by reference to the following description of preferred embodiments and with reference to the accompanying drawings in which:

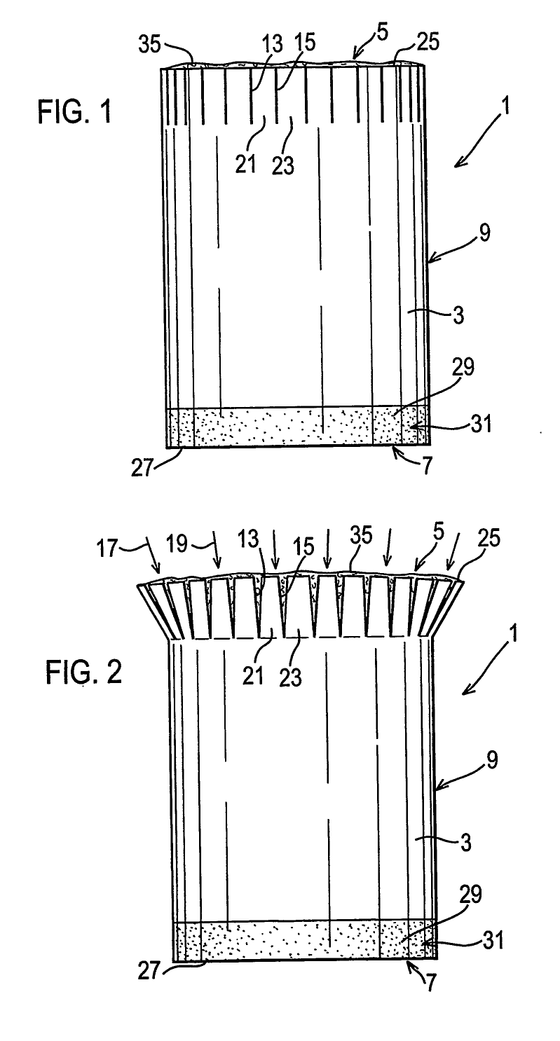

FIG. 1 shows a side elevation of a device according to the present invention prior to use;

FIG. 2 shows the device of FIG. 1 when subjected to pressure;

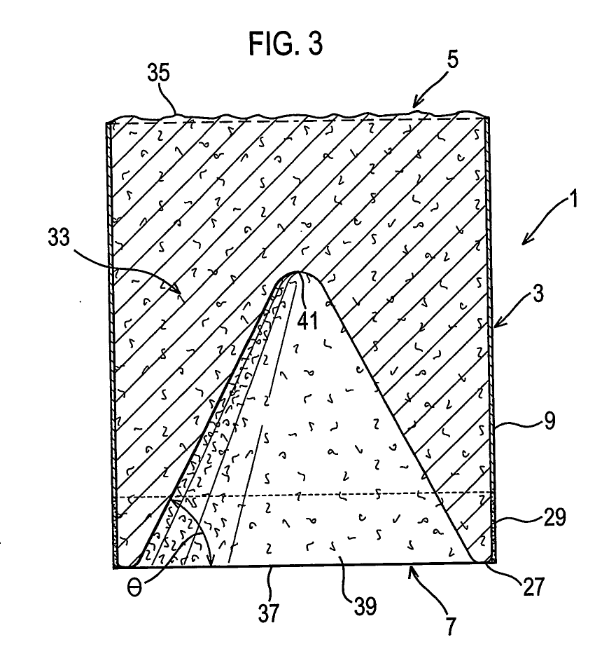

FIG. 3 shows a device according to the present invention in cross-section;

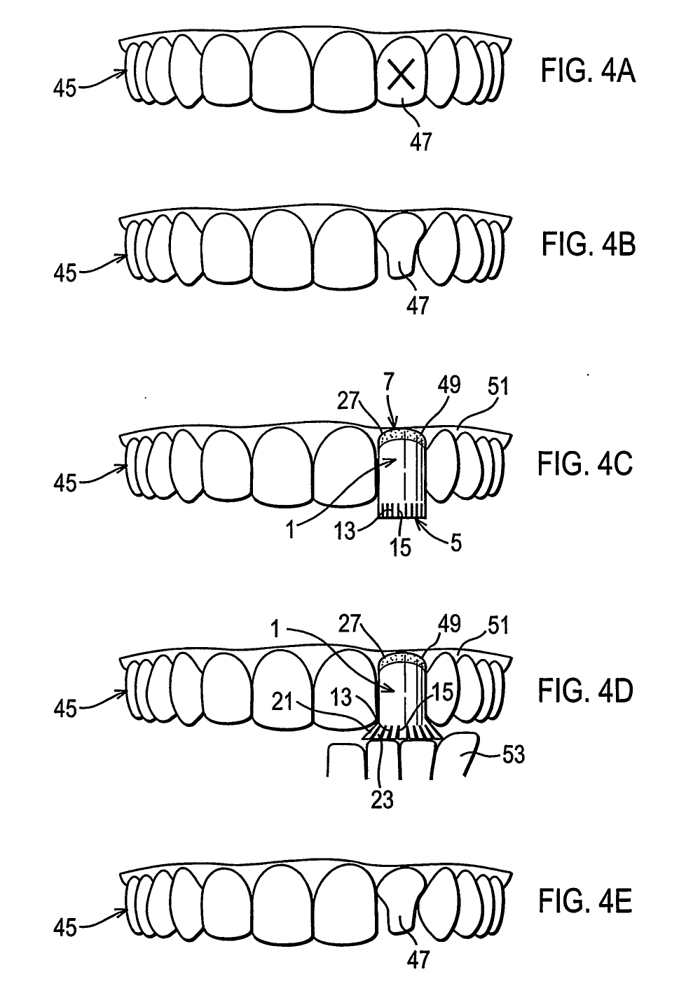

FIGS. 4A-4E sequentially depict the stages of tooth preparation and treatment utilising a dental device according to the present invention;

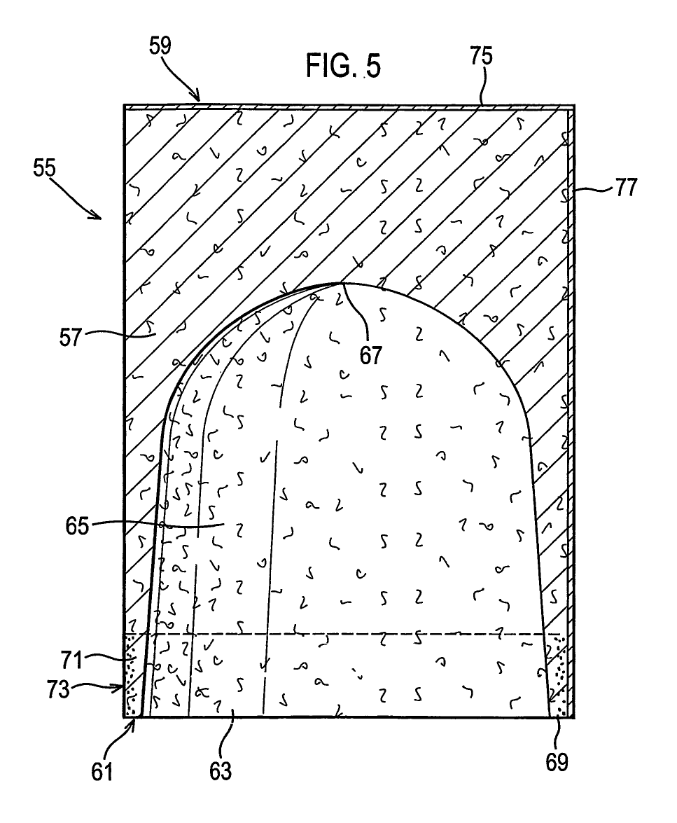

FIG. 5 shows an alternative preferred device according to the present invention in cross-section; and

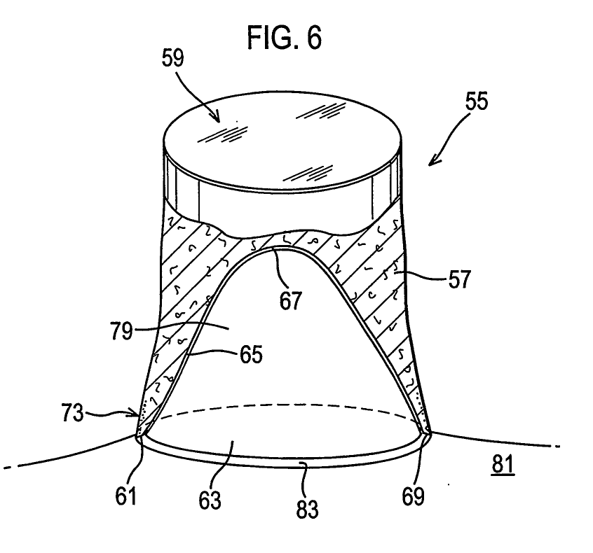

FIG. 6 shows a schematic view of the device of FIG. 5 in use, that is, when subjected to pressure.

FIGS. 1 to 3 show a device 1 according to the present invention. This device 1 is essentially a sheath provided with a cylindrical wall 3 and presents an upper end 5 and a lower end 7. FIG. 1 shows the device in side elevation before use and FIG. 2 shows the same device in side elevation when the upper end 5 is subjected to pressure during use as will be described further herein below with reference to FIGS. 4A-4E.

The cylindrical wall comprises an absorbent blotting paper tube 9. The upper end 5 is provided with circumferential slots 11, 13 etc running parallel to the cylindrical axis. As shown in FIG. 1, before use, these slots are substantially closed in the before-use configuration (FIG. 1) but when subject to pressure from above, on the upper surface 5, during use and as denoted by arrows 17, 19 etc, cause the segments 21, 23 between the slots, to splay apart so that the rim 25 at the upper end 5 is pushed outwardly (FIG. 2) so as to have, effectively, a wider diameter than that of the body of the cylindrical wall 3.

The lower circumferential margin 27 at the lower end 7 is impregnated in a region 29 around the lower circumference, with a haemostatic agent 31. In this particular embodiment, this region 29 is impregnated with racemic epinephrine hydrochloride at a concentration of 0.85 mg/inch (per 25.5 mm). The height of the impregnated region 29 from the lower end 7 is approximately 2 mm. Other non-limiting possible haemostatic agents are mentioned elsewhere in this specification but for patients with heart conditions, it would be appropriate to replace the epinephrine by, for example, a 25% aluminium chloride or 20% ferric sulphate solution.

Referring also to FIG. 3, which shows a cross-section through the device of FIGS. 1 and 2, the device inside the wall 3 contains a compressed cotton wool core 33 the upper end of which protrudes slightly in a region 35 above the rim of the upper end 5 of the device. The core 33 has formed therein, an opening 37 which is open to the air at the lower end 7. This opening 37 leads into a substantially conical cavity 39 which tapers in axial cross-section to a rounded apex 41 within the body of the device. The pitch of tapering denoted as angle θ is selected according to the particular size of device.

FIGS. 4A to 4E show the use of the device 1 in an operation of dental surgery such as fitting of a crown. These figures show an upper row of teeth 45, comprising a target tooth 47, depicted before treatment in FIG. 4A.

As shown in FIG. 4B, the target tooth 47 is first shaped (reduced in size) ready for offering-up of a dental crown (not shown).

Next, as shown in FIG. 4C, the device 1 of an overall size chosen according to the target tooth 47 in question, is placed over that tooth so that the upper end 5, at which slots 13, 15 etc are dispersed, points downwardly whilst the lower end 7, and in particular the rim 27 comes into contact with the gingival sulcus 49 of the gum 51. The haemostatic agent thereby prevents or inhibits bleeding.

As shown in FIG. 4D, contact between the rim 27 and the gingival sulcus is enhanced upon application of bite when the lower row of teeth 53 is brought together with the upper row 45 and the pressure resulting thereby splays the finger sections 21, 23 etc defined by the slots 13, 15 etc.

After sufficient contact time, to allow sufficient application of haemostatic agent to the wound, the device 1 is removed to leave the prepared target tooth 47, bleeding having in effect been slowed or stopped.

Finally, a suitable crown is applied by means of conventional cement over the clean dry and prepared tooth.

FIG. 5 shows an alternative preferred device 55 according to the present invention in cross-section before use. This device 55 is essentially a wool felt sheath provided with a cylindrical wall 57 which has an upper end 59 and a lower end 61. The device 55 has an opening 63 which is open to the air at lower end 61. This opening 63 leads into a cavity 65 wherein tapers in axial cross-section to a dome-shaped end 67 within the body of the device. The pitch of tapering is selected according to the particular size of the device. The external cylindrical wall 57 of the device is coated with gelatin to stiffen the wool felt. The lower circumferential margin 69 at the lower end 61 is impregnated in a region 71 around the lower circumference with a haemostatic agent 73. In this particular embodiment, the region 71 is impregnated with racemic epinephrine hydrochloride at a concentration of 0.85 mg/inch (per 25.5 mm). The height of the impregnated region 71 is approximately 2 mm. Alternative possible haemostatic agents are mentioned elsewhere in this specification. Colour coding, 75, 77 is applied to the upper end 59 and/or cylindrical wall 57 respectively.

FIG. 6 shows the device 55 in use in an operation of dental surgery such as filling a crown. This figure shows a target tooth 79 located in an area of gum 81. The device 55 is fitted over target tooth 79 and pressure is applied, either manually or by biting, to the upper end 59. This causes the lower circumferential margin 69 at the lower end 61 which bears haemostatic agent 73 to enter the gingival sulcus 83 thereby retracting the gingivae and controlling bleeding. It will be observed that the walls surrounding cavity 65 splay when pressure is applied thereby enabling the shape of cavity 65 to conform to the external contours of target tooth 79. This also facilitates entry of the lower circumferential margin into the gingival sulcus. Such entry is also facilitated by the narrow, “Knife-edge” profile of the lower circumferential margin 69 and further assisted by the use of gelatin to stiffen this area of the device.

The embodiments described above are given by way of example only and modifications of these embodiment, as well as other embodiments, all within the scope of the present invention, for example as defined by the appended claims, will now become apparent to persons skilled in the art.

1. A dental device comprising a sheath for fitting over a tooth, the sheath carrying a haemostatic agent in at least one region thereof, wherein the sheath comprises a generally cylindrical body having at least a first end and a second end, at least one of said first and second ends presenting a circumferential margin carrying at least part of the haemostatic agent, and wherein the at least one end carrying at least part of the haemostatic agent is open to a cavity and the other end is closed.

2. A dental device according to claim 1, wherein the cavity progressively narrows from its open end towards the closed end.

3. A dental device according to claim 1, wherein the cavity is dome-shaped at its closed end.

4. A dental device according to claim 1, wherein the generally cylindrical body comprises a cylindrical wall between said first and second ends, at least part of the cylindrical wall being stiffened.

5. A dental device according to claim 4, wherein the cylindrical wall is stiffened by application of a suitable non-toxic material.

6. A dental device according to claim 5, wherein the non-toxic material is gelatin.

7. A set of dental devices according to claim 1, the devices in the set being of different sizes.

8. A set according to claim 7, wherein the devices are colour coded to denote their respective sizes.

9. A method of inhibiting or preventing gingival bleeding, the method comprising placing over a tooth, a device according to claim 1.

10. A method of retracting gingivae, the method comprising placing over a tooth a device according to claim 1.

11. The method of claim 10 further comprising applying pressure to the device.

12. A dental device according to claim 1, wherein said closed end is constructed to yield upon application of pressure.
